(19) United States
(12) Patent Application Publication
(10) Pub. No.: US 2009/0063428 A1
(43) Pub. Date: Mar. 5, 2009

(54) Automated protocol screening to qualify patients to participate in a clinical trial

(76) Inventors: Alden Meier, Los Angeles, CA (US); David Davis, Los Angeles, CA (US)

Correspondence Address: Deborah Neville, PO Box 61063, Palo Alto, CA, 94306, US

(21) Appl. No.: 12/228,952

(22) Filed: Aug. 18, 2008

Related U.S. Application Data
(60) Provisional application No. 60/965,454, filed on Aug. 20, 2007.
(60) Provisional application No. 60/999,655, filed on Oct. 19, 2007.

(51) Int. Cl. G06F 7/06; G06F 17/30

(52) U.S. Cl. 707/3; 707/104.1; 707/E17.014; 707/E17.044

(57) ABSTRACT

The invention provides a consistent, easy to use, reliable method for evaluating each potential subject against the inclusion and exclusion criteria for a controlled data collection such as a clinical trial protocol. The invention provides a method for subject evaluation according to the clinical protocol as soon as the clinical protocol has been agreed upon. The invention provides an automated system and method of applying the clinical protocol to identifying and enrolling subjects. The invention removes both error (based on incomplete understanding or misunderstanding of the protocol) and inconsistencies owing to the subjective application. Further, to the extent physician subjectivity is affecting enrollment, the inventive system and method provides a means to monitor and quantify the subjective effect introduced into the clinical trial enrollment process.

### RELATED APPLICATIONS

This application claims priority from U.S. provisional application 60/965,454 filed Aug. 20, 2007 of the same title and named inventors. This application also is related to U.S. provisional application 60/999,655 filed Oct. 19, 2007, the entirety of which is incorporated herein by reference.

### GOVERNMENT FUNDING

Not Applicable

### FIELD OF USE

The field of use is generally computer assisted project management and training, including networked computers and particularly, computers connected via the Internet. More particularly, the field of use is training of Investigators for clinical trials of drugs or medical devices, including clinical trial management, protocol development, physician training, patient enrollment, and data analysis.

### BACKGROUND

Clinical Trials for new medical agents and devices are conducted according to a plan called a “Protocol.” The Protocol defines the types of patients who can participate in the trial, the schedule of tests and visits, the procedures, drugs, dosages, and the length of the study as well as the outcomes that will be measured. One of the most important aspects of Clinical Trials is finding and enrolling patients who meet the inclusion and exclusion criteria defined in the Protocol for the trial. The Protocol defines the conditions and attributes each patient must have or conversely must not have in order to be eligible to participate in the trial.

Currently, the doctors who are participating in the Trial are taught the inclusion and exclusion criteria during an Investigator Meeting where all aspects of the Trial are reviewed and explained. At the meeting, the doctors also receive paper documentation, including the Protocol. The Protocol is most often a voluminous and detailed document, and the complexity of the Protocol itself is a reason for the extensive training of doctors who will participate and enroll patients in the clinical trial.

After attending an Investigator Meeting, the doctors then return to their site where they implement the Protocol based on the training and documentation they received at the Investigator Meeting. The doctors are then expected to accurately apply the Protocol when identifying eligible subjects to participate in the Trial. The success of this process is largely based on the doctor's knowledge of the Protocol and their skill in applying that knowledge. A need exists for standardizing the application of the protocol particularly as it applies to the enrollment of study participants.

There have been some attempts at automating aspects of clinical trials. A system to automatically evaluate patient eligibility for randomized clinical trials, for example, was used retrospectively to assess the eligibility of a specified number of randomly selected subjects. However, the need still exists for automated enrolling and retaining trial subjects for clinical trials.

Another challenge in clinical trials arises from amendment of the trial protocol after commencement. Once a Protocol is implemented and enrollment in the Trial has begun, the Trial Management team may introduce Protocol Amendments, i.e. changes to the Protocol based on real-world experience. Currently, Protocol Amendments are documented in paper documents and sent to each doctor participating in the Trial. The doctors are then expected to immediately implement the amended Protocol and apply the revised procedures to each subject enrolled in the Trial from that point forward. In large trials where many physicians and sites are involved, the prompt implementation of amendments may be retarded, thereby damaging the prospects of obtaining the best data possible during the trial. What is needed is a means to propagate protocol amendments efficiently and enable immediate amendment implementation across all sites and among all physicians administering the clinical trial protocol. What is further needed is a means of storing data pertinent to implementation of protocol changes consistently within and amongst clinical trials.

Significant resources are spent training doctors on the Protocol, as the quality of the drug or device efficacy data is critical, and the protocol carefully designed to provide meaningful data. However, after training, there is no easy, convenient method for ensuring that each doctor is implementing the Protocol as it was designed and intended. This is especially true with respect to appropriate patient enrollment. According to the “Center for Drug Evaluation and Research 2001 Report to the Nation Improving Public Health through Human Drugs,” one of the top five deficiency categories for clinical investigator inspections was “failure to follow the protocol.” What is needed is an improved means of monitoring and enhancing protocol compliance during clinical trials.

Moreover, a research study conducted by Stanford University demonstrated that a large percentage of patients who were eligible to participate in the trial but were not enrolled because clinical staff performing enrollment assessment lacked proper understanding of the Protocol. According to the study, 22% of the people screened were rejected in error and that an additional 17% more were potentially eligible if controllable variables that could be changed by simple adjustments such as medication changes would have resulted in the patient being eligible for the trial. Failure to enroll eligible patients introduces experimental error into the trial. Further, inconsistent application of the Protocol when screening potential subjects significantly delays the trial completion. What is needed is an improved means to fully enroll the requisite number of subjects, especially through the reduction or elimination of improper rejections of subjects for any clinical trial. What is further needed is a means of eliminating sources of bias that are introduced uncontrollably by means of improper exclusions from a study cohort.

Enrolling a patient who does not meet the eligibility criteria defined in the Protocol is another costly error. Errors in applying exclusion criteria often go undetected. Even when such errors are detected, failure to adhere to the protocol exclusion criteria gravely affects the accuracy and validity of the trial data. What is needed is an improved means to accurately screen and disqualify from enrollment subjects who are not appropriate for the clinical protocol.

After a trial has commenced, as real world experience is gained during the trial, amendments can be and are made to the Protocol. Currently, when these Protocol Amendments are issued, not all sites and doctors implement the amended Protocol at the same time. The Trial Management team has limited or no information about who is using the old Protocol and who is using the amended Protocol and precisely when protocol amendments have been implemented. This introduces a major problem in the consistency of the application of the Protocol across the trial. Some method of ensuring that all sites and doctors are applying the amended Protocol is essential to ensure the integrity of the trial. There is also no ability to directly compare how the amended Protocol compares to earlier versions.

Currently, there is no detailed or summary record of the enrollment history for a Trial. While sites are required to keep records of enrollments, this data is often in paper form and is not easily accessible to the study sponsor. Since there is no detailed data, the pharmaceutical company or drug sponsor cannot use the valuable experience and data gained during the Trial to help design or implement future Trials.

Finally, many major pharmaceutical companies or drug sponsors run multiple trials in a therapeutic area. A patient who is evaluated for one trial and found to be ineligible may in fact be eligible for another trial. However, there is no easy method for finding those patients who have been evaluated for a trial and excluded as ineligible, but who are eligible to participate in another trial. It is often the case that more than one clinical trial may be conducted at a site. What is needed is a means to record the screening data in such a manner so that a subject, inappropriate for a given trial, may be rapidly evaluated based on collected screening data regarding appropriateness for a different trial conducted by the same company or sponsor.

### BRIEF SUMMARY OF THE INVENTION

The invention taught herein meets at least all of the abovementioned unmet needs. A primary focus for a Clinical Trial is to rapidly identify and enroll the requisite number of Protocol compliant eligible subjects so as to ensure that the trial is conducted and completed in the shortest possible timeframe.

The invention provides a consistent, easy to use, reliable method for evaluating each potential subject against the inclusion and exclusion criteria for the Protocol. The invention provides a method for subject evaluation according to the clinical protocol almost as soon as the clinical protocol has been agreed upon.

The invention provides an automated system and method of applying the clinical protocol to identifying and enrolling subjects. The invention removes both error (based on incomplete understanding or misunderstanding of the protocol) and inconsistencies owing to the subjective application. Further, to the extent physician subjectivity is affecting enrollment, the inventive system and method provides a means to monitor and quantify the subjective effect introduced into the clinical trial enrollment process. It should be noted that the invention does not imply to remove the physician from the decision-making process. The invention is designed to conclusively determine whether or not the patient meets the diagnostic criteria for the Trial based on the information that is entered. The physician is still required to answer subjective questions such as “Is this patient suited for the trial?” and “Is it in the patient's best interests to be enrolled in the Trial?” In some cases the patient may meet the diagnostic criteria but still may not be suitable for the trial based on the physician's knowledge of the patient or other circumstances.

An automated system according to the invention can apply the inclusion and exclusion criteria to data supplied by the doctor or support staff and determine whether or not the patient meets the diagnostic requirements to be enrolled in the Trial. The invention as taught herein relieves considerable time burden on busy physicians, who may otherwise feel compelled to either reject a subject, or to refer to a complex protocol repeatedly during the process of qualifying a subject for the clinical trial. The physician can appropriately delegate administrative aspects of data collection. The system provides for a physician to “click” on the computer enabled form, and see the precise protocol language applicable to a given criteria. The invention increases the speed, appropriateness, and consistency of determinations regarding subject eligibility for a clinical trial.

In an implementation according to the preferred embodiment, the inclusion and exclusion criteria contained in the Protocol for the clinical trial are reduced to a set of questions, possible answers for each question, and the correct answer for each question required for eligibility in the trial. All of the questions, possible answers, and correct answers are then entered into a database. In an alternative implementation, additional logic or rules can be incorporated into the system and/or database for those cases where a simple question and answer is insufficient to determine eligibility.

Not all criteria apply to all potential subjects. For example, if there is a criterion of “Is the subject pregnant?” only female subjects of child bearing potential are subject to this criterion. This criterion does not apply to Male subjects or post-menopausal women. Each Protocol is analyzed and broken down into the questions, possible answers, the correct answer for eligibility, and any additional logic that will allow the Enrollment Screener to be automated. The system provides the necessary logic to ensure that based on specific answers to specific, conditional questions are asked and/or logic is applied to the information entered. Each question can have a parent question and answer on which the child question is dependent. If the answer to the parent question does not require the child question to be asked, the system does not display the child question and it is not a factor in the eligibility of the subject.

Once the inclusion and exclusion criteria have been incorporated into the Enrollment Screener database, the system is tested to ensure that the screener accurately determines eligibility in all cases. Once the screener has been verified, it is made available to all physicians who are participating in the trial. The system requires each participating physician to have a username and password to ensure that the system is secure and is only available to doctors participating in the Trial.

The proposed system and method provides a network-enabled method to allow physicians to input the subject specific answers or values to the questions that make up the Protocol while they are screening a potential subject.

The system supports two types of screening evaluations:
1. Pre-screening. A Pre-Screening is done for a subject who is a potential participant whose medical history and background are being reviewed for eligibility. This is, in effect, data mining for potential participants.
2. Screening. A Screening is done for a subject who wishes to participate in the study and is being reviewed for eligibility.
   The primary difference between a Pre-Screening and a Screening is that for a Pre-Screening, some information may not be known about the patient. For example, the person doing the pre-screening may not have an up-to-date pregnancy test on file and therefore cannot enter a definitive response to this criterion. For selected questions such as these, the administrator can allow a “Don't Know” option to be entered. The user can then mark the question as “Don't Know” while they are completing the Pre-Screening. When the system evaluates a patient's eligibility, questions that have been marked “Don't Know” are not included in the logic that determines whether or not the patient is suitable for the Trial. This allows a site to go through their medical files in search of patients who may be good candidates for the Trial.

The system provides a visual indication that allows a user to quickly determine whether they have selected to perform a Pre-Screening or a Screening. The system displays a Pre-Screening with a shaded background and a Pre-Screening icon. A screening is displayed with a white background and a Screening icon.

The system also supports the easy transition from a Pre-Screening to a Screening. In this case, whenever a user elects to view or edit a Pre-Screening they are provided the option to convert it to a Screening. Once the user has elected to convert a Pre-Screening, the system requires that the user answer all of the questions that were marked “Don't Know” during the Pre-Screening. In addition, the system requires the user to confirm that all of the values that were entered during the Pre-Screening are still correct by checking a checkbox. For both Pre-Screenings and Screenings, the system provides the same functionality, subject to some exceptions as described above.

After entry of the subject's information, the system automatically determines whether or not the subject is (i) eligible for enrollment, (ii) ineligible for enrollment, or (iii) potentially eligible for enrollment for the Trial. A subject is eligible for enrollment if they meet all of the Inclusion Criteria contained in the Protocol and don't fall into any of the Exclusion Criteria. A subject is potentially eligible if they do not completely fall within the criteria but potentially could fall within the criteria if some action is taken (e.g. take a cholesterol reducing drug to lower their LDL cholesterol). The system allows a physician to conduct the screening across multiple sessions in the event that they do not have all of the necessary information to complete the screening.

The system does not capture or store any personal identifiable information about the subject being evaluated. The person entering the data enters the subject's initials and birthdate to help identify the patient in the future. The system generates a random number for the subject. Once the evaluation has been completed, the physician can print a report where the patient's identification information can be hand written on the results of the evaluation. If the evaluation record for the patient is to be retrieved, the physician can search for the patient using the random generated number, entering the patient's initials, or by entering the date or date range when the subject was evaluated. This provides the subject anonymity with regards to the trial but allows the subject to be re-contacted should the need arise. In an alternative implementation, the subject's personal identification information can be entered and stored along with the results of their evaluation. The physician can than search for the subject using their personal identification information.

The system allows the physician to create and print a calendar of site visits as required in the Protocol for those subjects who are eligible and elect to enroll in the Trial. This allows the physician and the patient to immediately begin to apply the Protocol and schedule the necessary visits before the subject leaves the physician's office.

Regardless of the subject's eligibility, the system saves the enrollment attempt and all of the data and makes the information available to physician and to the Trial Management team. The management team can then analyze the data coming in from the field to determine how many enrollments are successful, how many enrollments are failing, which sites are failing large numbers of enrollments, and the areas of the Protocol where the largest numbers of failures are occurring in near real-time. The system tracks all updates made to an enrollment evaluation and saves all of the previously entered information in order to preserve a history of the changes that have been made and by whom.

The Trial Management team can use the incoming data to determine whether or not the Protocol is working or if amendments are needed to increase the enrollment success rate. For example, if a large number of potential patients are falling just outside the boundary value of specific enrollment criteria, the Protocol may be amended to allow those borderline patients to be included in the trial. In addition, if a specific criteria is eliminating a disproportionate number of otherwise eligible subjects, that criteria may need to be reviewed and possible changed or eliminated to allow the trial to proceed at a faster pace.

Once a Protocol amendment has been made, it is published and immediately made available to all physicians participating in the trial. This allows Protocol amendments to immediately be deployed into the field and ensures uniformity of application across all sites at exactly the same time. Each Protocol version is uniquely identified and has starts and end date/times so that analysis can be performed across previous versions.

The system can also be configured to allow different sites to use different versions of the Protocol if amendments have been issued. This is necessary because on certain Trials, sites use local Institutional Review Boards (IRBs) rather than a central IRB. The local IRB must approve the amended Protocol before the site can begin implementing it. In these cases, a Trial can have some sites using the older version of the Protocol and other sites using the amended version of the Protocol. If a central IRB is being used on the Trial, then all sites can convert to the amended Protocol once approval has been granted.

In addition, the system can be used to retroactively analyze previously failed enrollments to determine which subjects would now fall within the amended Protocol inclusion/exclusion criteria. Sites can then be contacted and they can reestablish contact with the subjects who may now be eligible and they can be re-screened and potentially be enrolled in the trial.

The Trial Management team can use the system to perform “what if” scenarios while they are developing the protocol or once the Protocol is being used to see how changes to the Protocol will affect the enrollment numbers and extrapolate the rate of enrollment with an amended version. The Trial Management team can also perform analysis on the data across multiple trials to determine whether or not subjects excluded from one trial are eligible for any other trials.

At the end of the Trial, all of the enrollment data is archived and kept in electronic and/or paper format. Currently, there is no easily accessible record of the detailed enrollment history for a Trial. This data can be used as an aid to developing future trials or simply as a record of what happened on the Trial.

For additional discussion, including system configurations, hardware and network components, the reader may refer to three related co-pending applications, 60/903,662; 60/958,062; and 60/958,054, and the PCT or US utilities claiming priority therefrom, the entireties of each of which are incorporated by reference as if fully set forth herein.

### BRIEF DESCRIPTION OF THE DRAWINGS

FIG. 1 (intentionally omitted)

FIG. 2 is an exemplar “Element Extraction” from a Clinical Trial Protocol according to the preferred embodiment.

FIG. 3 provides an exemplar “Secure Login” display screen according to the preferred embodiment.

FIG. 4 provides an exemplar “Start New Screening” display screen according to the preferred embodiment.

FIG. 4 provides an exemplar “Screening Retrieval Record Form” according to the preferred embodiment.

FIG. 6 provides an exemplar “Screening Instructions” display screen according to the preferred embodiment.

FIG. 7 provides an exemplar “Screening Checklist” display screen according to the preferred embodiment.

FIG. 8 provides an exemplar “Pre-Screening” display screen according to the preferred embodiment.

FIG. 9 provides an exemplar “Screening” display screen according to the preferred embodiment.

FIG. 10 provides an exemplar “Pre-Screening Result” display screen according to the preferred embodiment.

FIG. 11 provides an exemplar “Screening Result” display screen according to the preferred embodiment.

FIG. 12 provides an exemplar “Search for Screening” display screen according to the preferred embodiment.

FIG. 13 provides an exemplar “Convert Pre-Screening to Screening” display screen according to the preferred embodiment.

FIG. 14 provides and exemplar “Reporting” display screen according to the preferred embodiment.

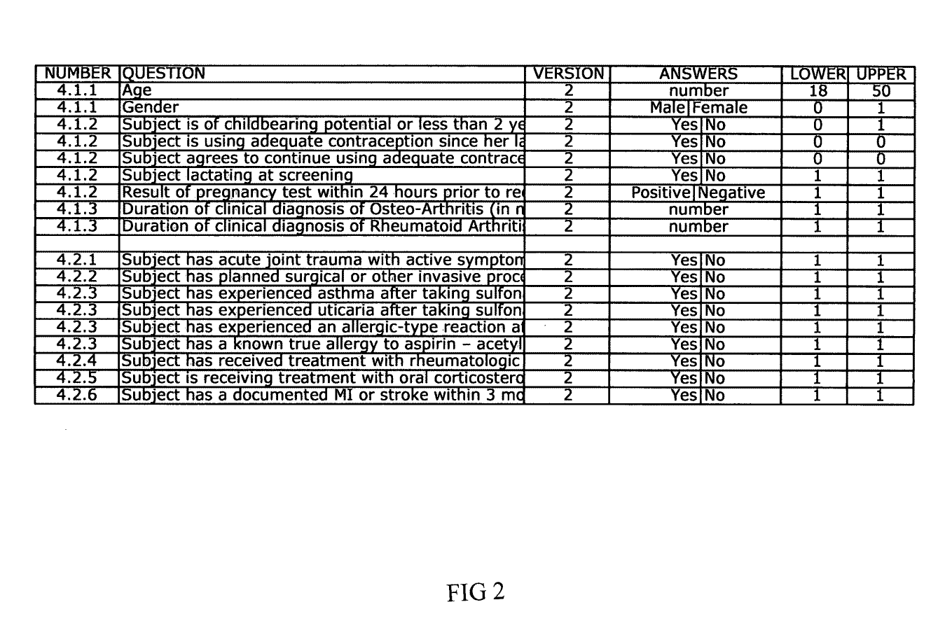

### DETAILED DESCRIPTION OF THE PREFERRED EMBODIMENT

The invention herein is discussed and may be further appreciated by reference to the accompanying appendices. When a new Clinical Trial is initiated, the Trial Management team and support staff develops and writes the Protocol, or Clinical Protocol, for the trial. The Clinical Protocol provides the inclusion and exclusion criteria which will be used to qualify subjects who will be eligible to participate in the Trial. The result is a written document outlining the Clinical Protocol. An Example of such a Clinical Protocol, entitled SAMPLE CLINICAL PROTOCOL, is included as Appendix 1.

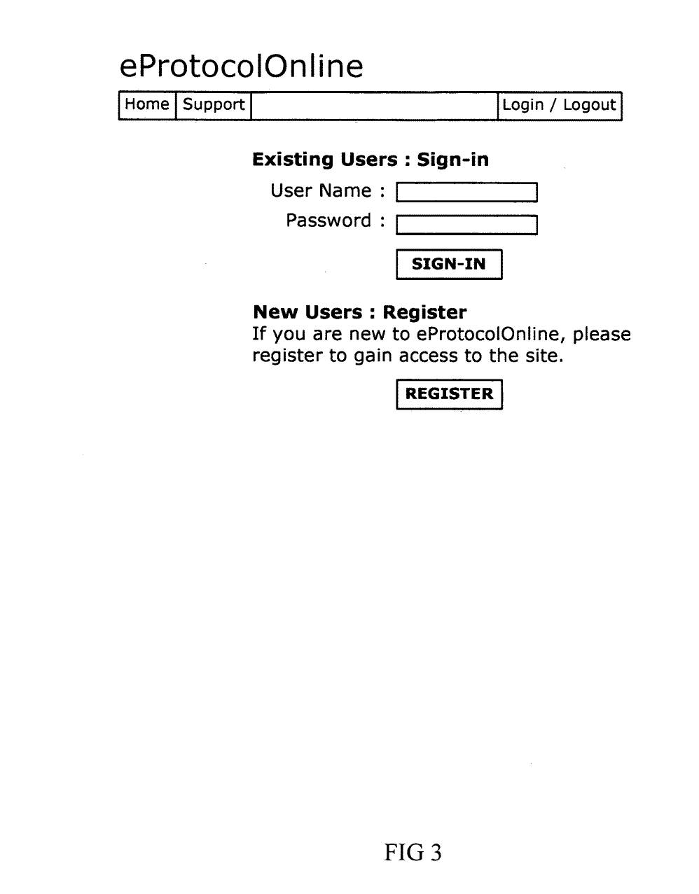

Once the Clinical Protocol is defined and the eligibility criteria established, the invention provides for reduction of the criteria to their basic elements (typically in the form of questions and expected answers). The “element extraction” provides restatement of Clinical Protocol such that the restatement of the inclusion and exclusion criteria may be incorporated into a computer system. An example of such a restatement of criteria in the form of questions and expected answers is depicted in FIG. 2, denominated “Element Extraction.” FIG. 2 illustrates the extraction of criteria as provided in the SAMPLE CLINICAL PROTOCOL (Appendix 1). In the current embodiment, an Enrollment Screener as exemplified in FIG. 2 derived from a clinical protocol such as the SAMPLE CLINICAL PROTOCOL, is created manually. However, the invention contemplates embodiments wherein a clinical protocol may be rendered automatically into a form such as that depicted in the enrollment screener. As the participating physicians are trained on the Clinical Protocol, it is contemplated that such physicians are likewise trained in the use the of the automated Enrollment Screening application as provided by the invention.

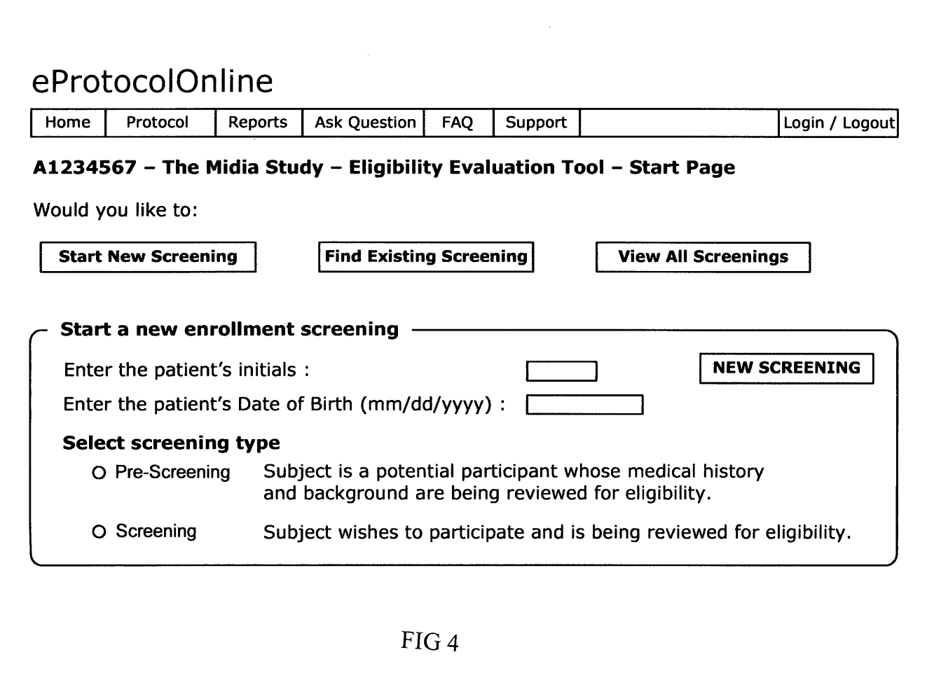

Once the physicians return to their sites and begin to enroll patients, they access and use the Enrollment Screener over a network for each subject that is evaluated for possible enrollment in the Trial. FIG. 3 illustrates that the inventive system requires users to securely login in order to authorize their access to the system and to track the screenings that they perform. Each user must be created by an administrator before they can access the system.

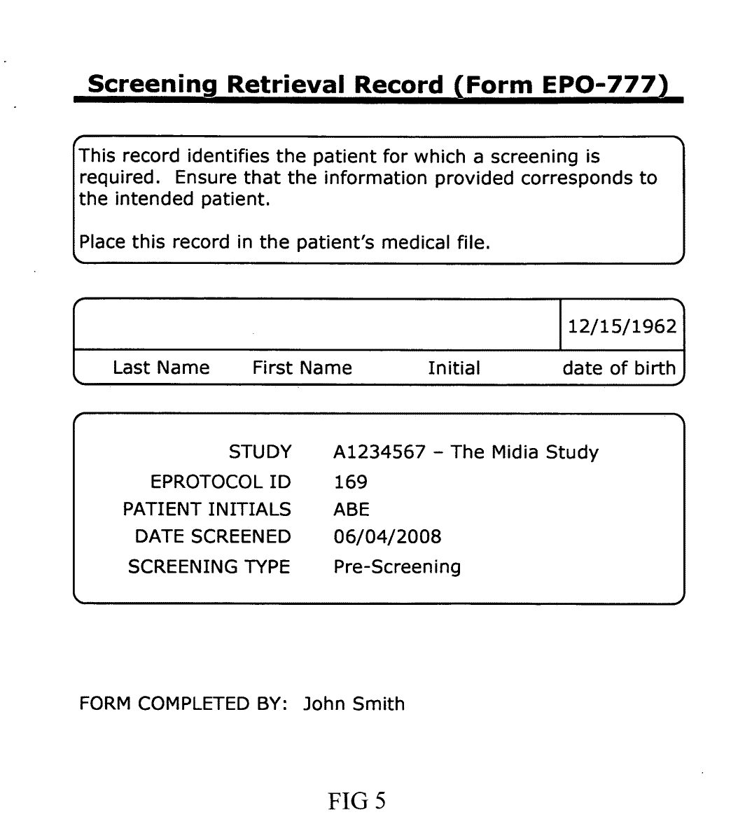

Once a user has securely accessed the system they are required to provide the users initials and birthdate and to select the type of screening they wish to perform as illustrated in FIG. 4. Although the current invention does not require Personal Identifiable Information, this information is not precluded in future embodiments.

FIG. 5 is an example of a Screening Retrieval Record Form. If the enrollment attempt spans multiple sessions, the physician can retrieve the partially completed form using the randomly generated number, the patient's initials, or the date that the original screening was performed. All of this information is recorded on the Screening Retrieval Record Form.

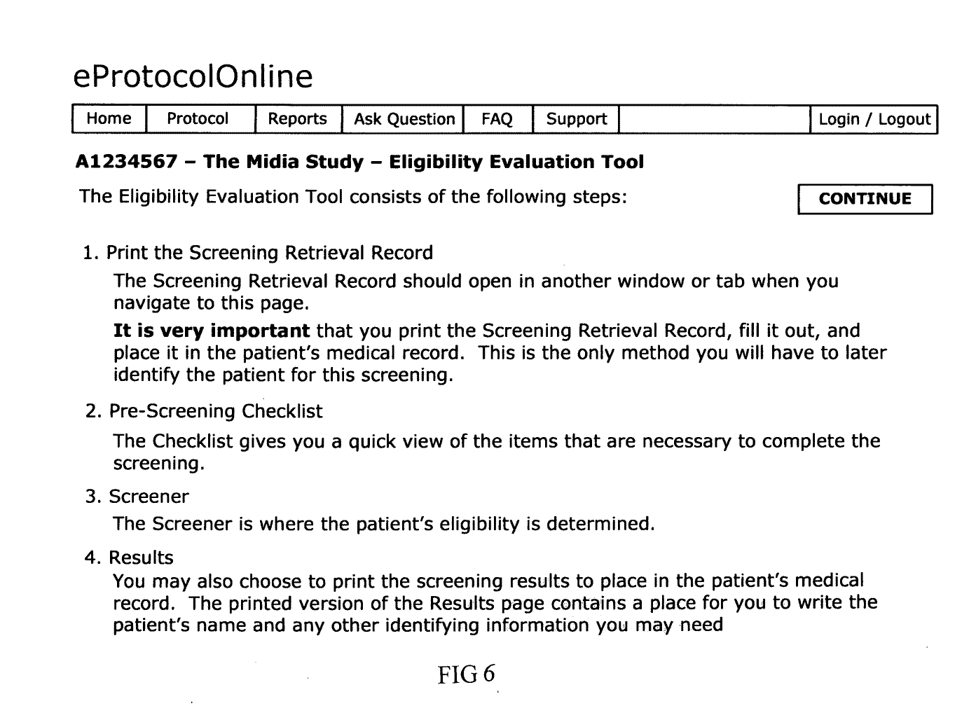

As many physicians will use the system infrequently, Screening Instructions are displayed for each new screening as illustrated in FIG. 6.

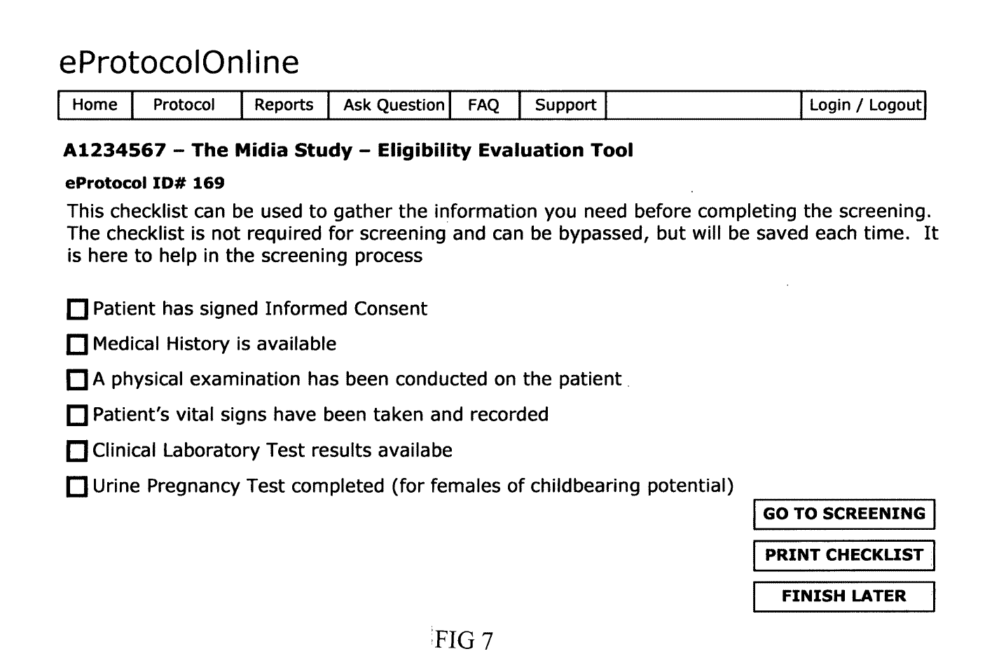

FIG. 7 illustrates the ability of the system to generate a Screening Checklist to assist users and ensure that they have collected all of the necessary information about the patient before they attempt to perform a screening. This checklist is optional per Protocol.

The inventive system includes an electronic form that physicians can input the patient's information, validation for the form so that only correct information can be entered, a database that stores the criteria in the form of questions and answers, and the logic that takes the entered data and determines whether or not the subject meets the enrollment criteria as defined by the current Protocol. All of these elements make up the Enrollment Screening application.

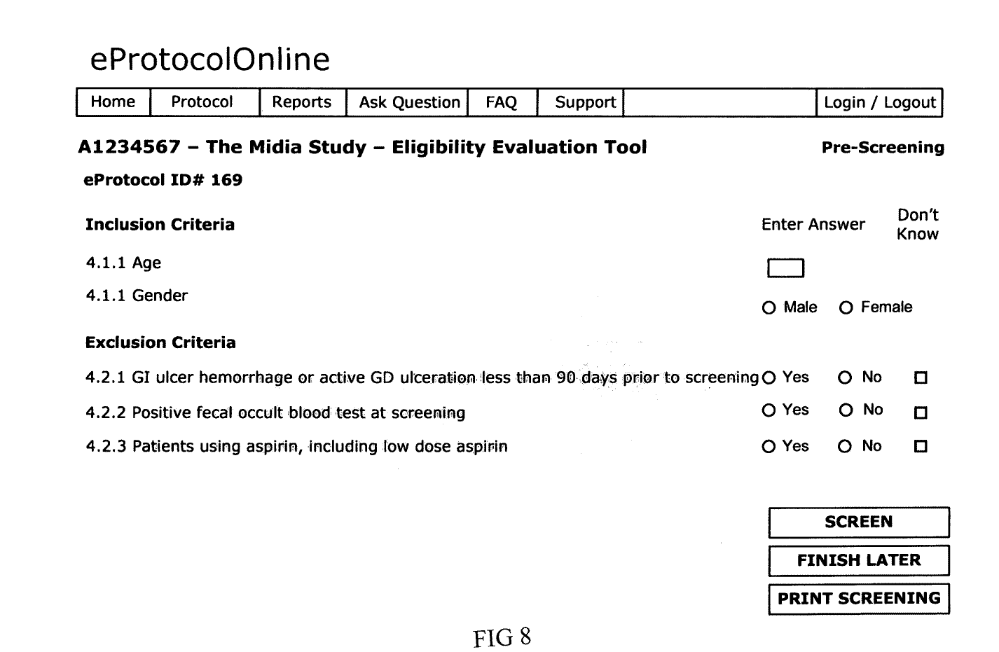

FIG. 8 illustrates the application and form that is displayed if the physician wishes to perform a pre-screening. For this type of screening, typically all that is available is a patient's medical file and not all of the information about the patient may be obtainable from their file. In this mode, the system allows a value of “Don't Know” for specified questions. For some questions, “Don't Know” is not an option and the physician must enter a value.

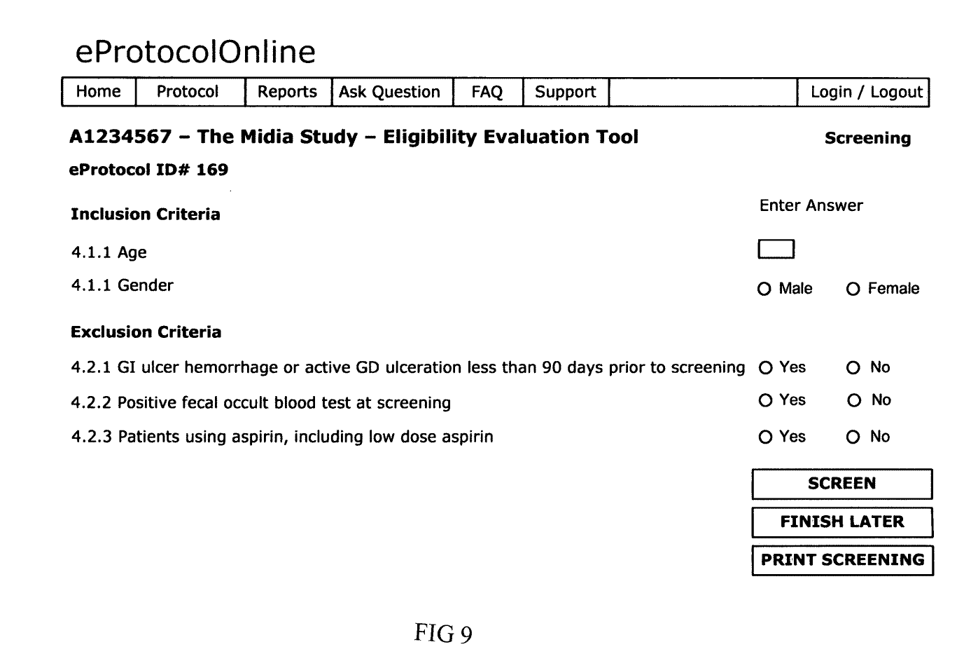

FIG. 9 illustrates the application and form that is displayed if the physician performs a screening. For this type of screening, the Physician will have access to up-to-date information for the patient and must provide the answers to each of the inclusion/exclusion criteria in order to evaluate the patient.

Each enrollment evaluation is entered into the Enrollment Screening application and assessed based on the inclusion and exclusion criteria. In the primary implementation, the criteria are in the form of questions and answers that the physician enters into the Enrollment Screener form. The Enrollment Screener then processes the entered data using the inclusion/exclusion criteria defined for the trial and applies the necessary logic to the data. The enrollment attempt outcome is: (i) eligible, (ii) not eligible, or (iii) potentially eligible. The system saves the data and allows the physician to print an enrollment eligibility summary for inclusion in the patient's file.

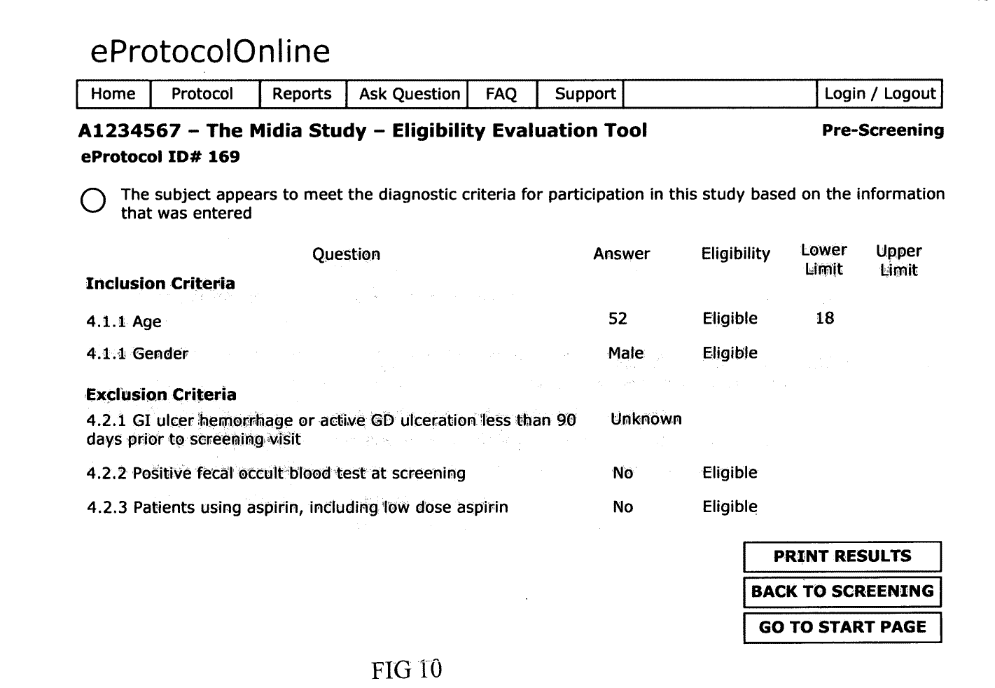

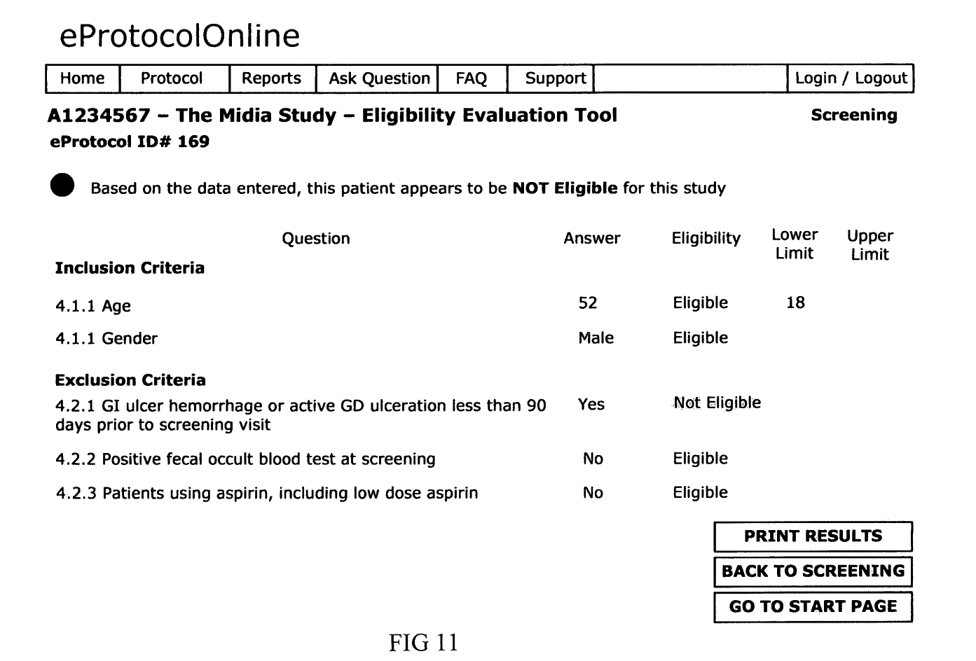

FIG. 10 illustrates an example of Enrollment Screener results for a Pre-Screening according to the preferred embodiment. FIG. 11 illustrates an example of Enrollment Screener results for a Screening. For either type of screening, the physician writes the subject's personal identification information on the printed form and places the form in the patient's file.

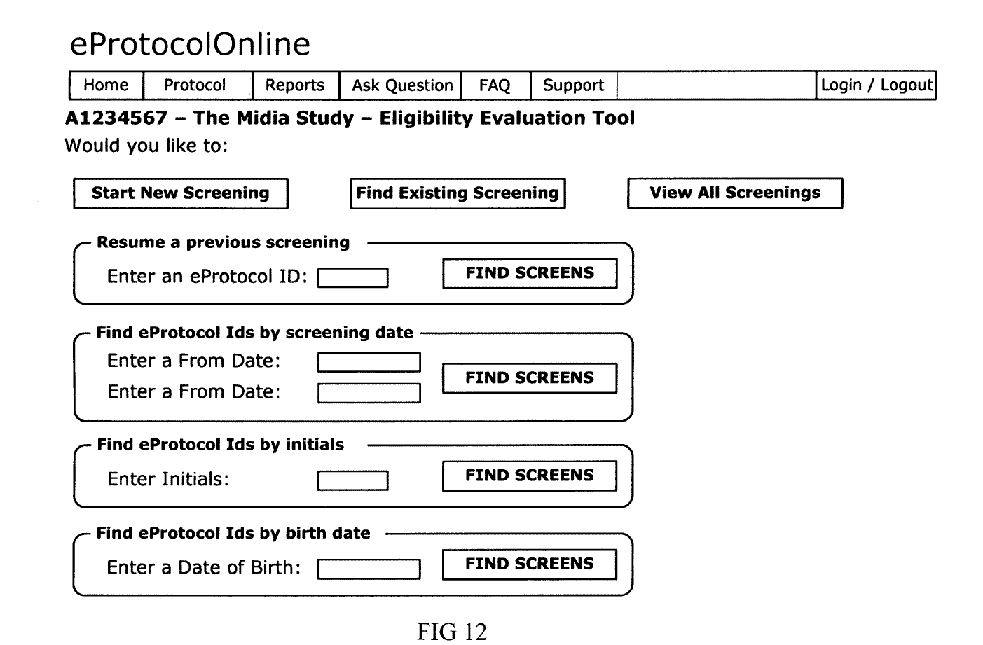

In the event that a Physician or other user needs to retrieve a Pre-Screening or Screening that partially or entirely completed in a previous session, the system provides a search mechanism to access the screening. FIG. 12 illustrates an exemplar of a form used by the Physician to find previous screenings.

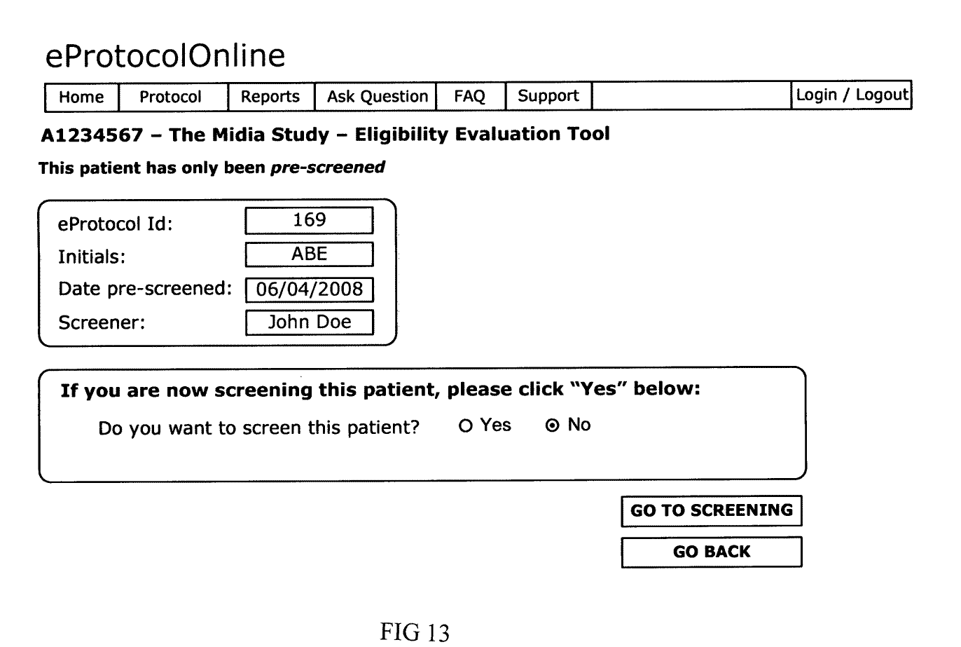

FIG. 13 illustrates the method for a Doctor to convert a Pre-Screening to a Screening. The system allows this conversion to happen at any time and all of the data entered for the Pre-Screening is brought forward into the Screening. When this occurs, the data from the Pre-Screening is preserved so that the history is available should the need arise.

The system taught herein also provides references back to the Trial Protocol for each inclusion and exclusion criteria on the form. The doctor can quickly refer to the actual section of the Protocol to which the criteria relate. This allows the doctor to very quickly determine the context of the criteria and provides a means to develop a deeper understanding of the Protocol over time. Additional textual help is also available to the doctor to provide additional information to ensure that the doctor fully understands the data that is being collected.

The Trial Management team accesses the network-enabled system to view the up-to-date results of the enrollment process. Trial Management team members can see enrollment data as soon as the doctor has entered it, and can either choose to view a summary view of the information or to view the raw data. Further, Trial Management personnel can also export the data from the database into other tools for analysis. If trends are detected, the Trial Management team can follow up with an amended protocol or take other action where necessary to ensure that enrollment is going as quickly and as accurately as possible. In an alternative implementation, Trial Management teams from other trials can export and analyze the data to see if excluded subjects are appropriate for enrollment in their trial.

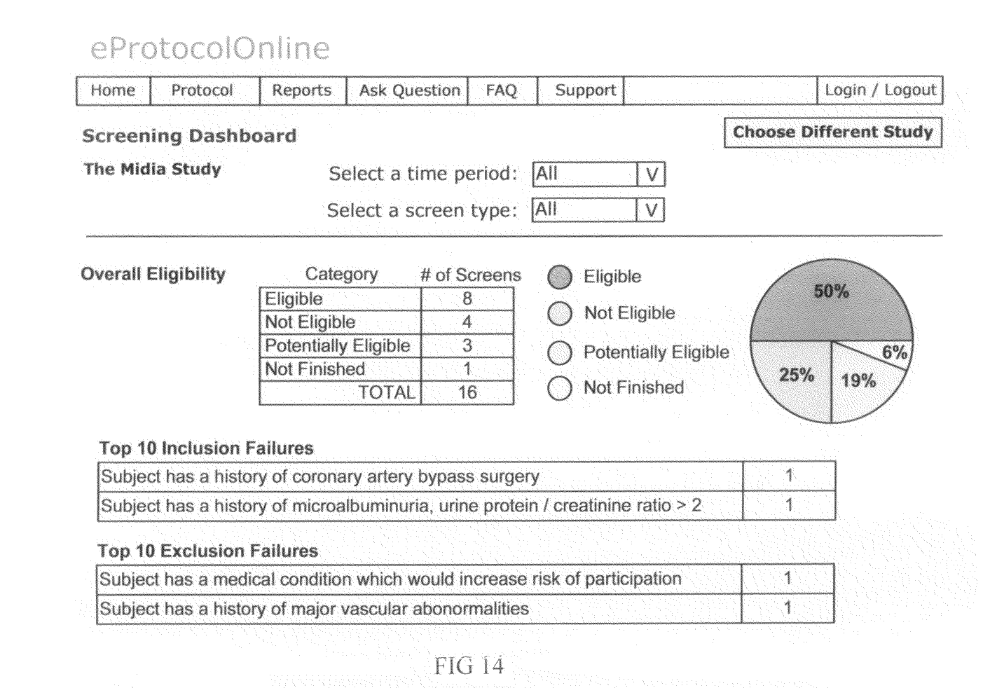

FIG. 14 illustrates the preferred embodiment of the summarized data available to the Trial Management team. At the end of the Trial, all of the enrollment data can be transferred to acceptable long-term storage media and kept as part of the records for the Trial. The archived data can be analyzed and used in the development of future Trials.

Although the specification discusses the invention as applied to clinical trials and most particularly pharmaceutical clinical trials, the invention is applicable to medical device trials, and any other application where criteria must be applied in a consistent manner. The invention is further useful in time critical applications: applications in which data collection process and storage provided by the inventive system and method enable fast, complete visibility of data, as well as data storage and cross population or analysis.

We claim:

1. A method for screening subjects for participation in a controlled data sampling process, such as a clinical or medical device trial protocol, said method comprising the steps of:
extracting protocol criteria, where such extraction provides discrete queries and value selections, where response to said answer selection are useful to determining participant eligibility;
creating means to present such extracted protocol criteria extraction to entity responsible for patient enrollment in clinical trial, such that responsive data associated with a subject may be collected; and
means to determine subject eligibility to participate in said controlled data sampling process where such determination is based on responsive data associated with said subject.

2. The method as in claim 1 wherein said means to present criteria extraction is a computer fillable form, wherein responses dynamically tailor presentation of subsequent questions presented on said computer fillable form, and where data entered on said form is captured for storage and analysis.

3. The method as in claim 2 wherein said data entered on said computer fillable form is analyzed by computing means and eligibility with respect to study participation in determined and communicated by output from computing means.

4. The method of claim 1 wherein the step of extracting includes modification of a pre-existing protocol enrollment form.

5. The method of claim 1 wherein enrollment data is stored and searchable for compatibility with other trial protocols.

6. A system for automated collection and assessment of data in a controlled data sampling process, said system comprising:
devices for data input, said devices networked with a least one server;
server, said server capable of implementing logic supporting GUI on data input device, supporting analytic functions, including database creation, search and analysis, and hosting at least one database;
storage device for storage of data;
where said system enables immediate access to
data sampling information, monitoring of implementation of any data sampling process changes during the course of the data sampling, and, enables high-speed high quality statistical analysis.

7. The system of claim 6 wherein said controlled data sampling process is a clinical trial, where such clinical trial has a protocol for patient enrollment.

8. The system of claim 7 wherein the device for data input display dynamically tailorable GUI, where said GUI presents clinical trial enrollment criteria in such a manner as to automatically determine, based on input of data in response to data queries, whether the patient is eligible for enrollment in said clinical trial.

9. The system as in claim 8 wherein the devices for data input are connected to an intranet.

10. The system as in claim 8 wherein the devices for data input are connected to an extranet.

11. The system as in claim 6 wherein said storage of data further includes means to retrieve and analyze data according to at least one parameter of said controlled data sampling process.

12. The system as in claim 6 wherein said system facilitates rapid dissemination and implementation of changes in the data sampling process such that precise records of the data sampling process and implementation of changes thereto are tracked and preserved.

13. The system as in claim 8 wherein said storage of data further includes means to retrieve and analyze data according to at least one parameter of said controlled data sampling process.

14. The system as in claim 8 wherein said system facilitates rapid dissemination and implementation of changes in the data sampling process such that precise records of the data sampling process and implementation of changes thereto are tracked and preserved.

15. The system as in claim 8 wherein determination of eligibility includes an assessment of one or more different clinical trial protocols, such that ineligibility of any study may result in determination of eligibility for other clinical trials.

16. The system as in claim 15 wherein said assessment includes medical device trial protocols.
